(19) United States
(12) Patent Application Publication
(10) Pub. No.: US 2012/0034483 A1
(43) Pub. Date: Feb. 9, 2012

(54) DECORATIVE COMPOSITE ELEMENT

(76) Inventor: Oliver MAIR, Imst (AT)

(21) Appl. No.: 13/273,314

(22) Filed: Oct. 14, 2011

Related U.S. Application Data
(63) Continuation of application No. PCT/AT2010/000094, filed on Apr. 2, 2010.

(30) Foreign Application Priority Data
Apr. 21, 2009 (AT) GM 249/2009

(51) Int. Cl. A47G 35/00; B23P 11/00

(52) U.S. Cl. 428/542.6; 29/428

(57) ABSTRACT

Disclosed is a decorative element (1) comprising two substantially parallel panels (2, 3) which are arranged at a distance from each other and at least one of which (2, 3) is at least partially permeable to visible light, and a plurality of precious stones (6) that are disposed between the panels (2, 3). A device (4) for fixing the precious stones (6) in a specific position is located between the panels (2, 3). Said position-fixing device (4) includes compartments (5), inside each of which exactly one precious stone (6) is disposed. At least one of the panels (2, 3) directly adjoins the compartments (5).

The invention concerns a decorative element comprising two mutually spaced substantially parallel panels, wherein at least one of the panels is at least partially translucent for visible light, and a plurality of precious stones arranged between the panels, wherein disposed between the panels is a device for fixing the position of the precious stones and wherein the position-fixing device has compartments in which precisely one respective precious stone is arranged.

For the optical decoration of living rooms it is known to arrange decorative elements between panels, wherein at least one of the panels is at least partially translucent to visible light in order to protect the decorative elements from external influences on the one hand and on the other hand, by the composite structure of the decorative elements with the panels, to provide a decorative element which in turn is optically attractive and is suitable for decoration. In addition such an arrangement of decorative elements between for example two glass panels makes it possible to improve the appearance of cupboard doors, living accommodation doors or windows which have such glass panels.

EP 0 240 584 A1 discloses a process for the production of decorative composite glass panels, wherein disposed between two glass panels is a layer of adhesive into which foreign bodies, for example pieces of glass, are introduced for decoration purposes. Besides the large-area application of adhesive which is necessary for that purpose, it has been found in that respect that positioning of the decorative elements between the glass panels is possible only to an unsatisfactory degree. In particular it is difficult to represent patterns, for example ornaments, with those decorative elements. A further disadvantage is that an arrangement of the decorative elements which are glued in place, once it has been fixed, can no longer be released.

GB 2 446 242 discloses a decoration panel arrangement comprising two glass panels, between which a fixing device is arranged, wherein the fixing device has latching elements in the form of projections into which the precious stones are clipped. A disadvantage there is that the demands made on the production accuracy of the fixing device for clipping engagement are high and in addition the precious stones have to be individually arranged in the latching elements, in a complicated and expensive procedure.

GB 2 360 742 concerns a decorative panel assembly with two mutually spaced glass panels, wherein glass balls are held between the glass panels by means of adhesive. In addition arranged between the glass panels are wires, by means of which the glass balls produce a given pattern. In that case the wires are suitable only as coarse subdivisions or compartments for the precious stones. It is not possible for precious stones to be positioned and secured in place by the compartment wires, and for that reason the precious stones have to be held to the glass panels with adhesive.

The object of the invention is to provide a decorative element having two mutually spaced substantially parallel panels having a plurality of precious stones arranged between the panels, wherein the precious stones can be arranged between the panels in a technically simple fashion in a positioning relationship as desired, wherein unintentional escape of the precious stone from the decorative element or slippage of the precious stones over a large area is to be prevented.

That is attained by a decorative element having the features of claim 1.

At least one of the panels is at least partially translucent to visible light. That panel therefore forms the visible side of the decorative element, where the precious stones disposed in the substantially parallel panels can be viewed. It will be appreciated however that it can also be provided that both panels are at least partially translucent to visible light, whereby the precious stones can be seen from both sides and the decorative element according to the invention can thus be used more independently as a decorative design element. In that respect ‘partially translucent’ means that the panel is completely transparent or colored or also translucently colorless or colored with a certain degree of opacity.

The panel which is at least partially translucent to visible light, together with the panel arranged in substantially parallel and spaced relationship therewith forms a positional fixing means for the precious stones to be arranged between the panels, in a direction perpendicular to the panels. If now a plurality of precious stones is arranged between the panels displacement or slippage in a direction parallel to the plane of the panels cannot be prevented thereby. It is equally not possible to position the precious stones as desired for example in an ornamental arrangement.

If now a device for fixing the precious stones in position is arranged between the panels, the specific design configuration of the position-fixing device makes it possible to position the precious stones as desired, in particular in the directions parallel to the plane of the panels, between the panels, wherein the position of the precious stones in the arranged condition between the panels is determined substantially by that device. In that respect ‘positional fixing’ does not necessarily signify that the precious stones are connected to the device in positively locking relationship. It can certainly be provided that a movement, even if slight, of the precious stones in the arranged condition can occur, for example in a direction parallel to the panels. That movement can be limited for example by the edge surfaces of the device. Large-area slippage or unintentional escape of the precious stones from the decorative element is no longer possible. That is also useful during production of the composite panel assembly, that is to say the entire decorative element. In that respect the position-fixing device is preferably made from a light material, that is to say for example plastic, wood or light metal.

The device for fixing the precious stones in position has subdivisions or compartments in which the precious stones are arranged, thereby permitting individual ones or a given proportion of the precious stones arranged overall between the panels to be fixed in position. That makes it possible to take account of the size of the precious stones. Arranging the precious stones in the compartments of the device also permits the stones to be uniformly divided out. In that respect the compartments can be of such a configuration that the precious stones are held in a direction parallel to the panels, by the compartments. It can also be provided that the compartments are of such a size and are of such a configuration that the precious stones are held in positively locking relationship by the compartments.

By virtue of such compartments it is possible for the positional fixing for the precious stones to be such that the precious stones can be arranged over a large area between the panels. In the case involving conventional glueing on a large-area region of the precious stones, a particularly large amount of adhesive would be necessary for that purpose. In this respect positional fixing can mean that the precious stones are held in a direction parallel to the panels within the compartment, for example by the edge surfaces of the compartments, but are movable in the compartments at least within certain limits. The more accurately that the sizes of the compartments and the precious stones match, the correspondingly more is that freedom of movement limited.

The compartments are of such a size that precisely one respective one precious stone can be arranged in the individual compartments, thereby ensuring that the stones are fixed in position by the compartments themselves in a particularly simple fashion. If there is only space for one precious stone in a compartment, the stone can also no longer slip so that the arrangement of precious stones can be particularly easily fixed. In this case moreover holding the stones in place in a direction parallel to the plane of the panels or a positively locking connection between the precious stones and the compartments is particularly easily possible as the size of the compartments is matched to the respective precious stones used. In addition that permits the plurality of precious stones to be distributed between the panels homogeneously in relation to the normals to the panels.

Because at least one of the panels directly adjoins the compartments the precious stones can be arranged in the compartments, wherein the position-fixing device can already be arranged with the compartments on the panel that the compartments directly adjoin, thereby permitting the stones to be arranged in particularly simple fashion. The precious stones can no longer fall of their own accord out of the compartments on that side of the compartments, that the at least one panel directly adjoins. In particular the precious stones do not have to be glued on to the panels as they are held by the compartments. It can be provided for example that the panel that the compartments directly adjoin is placed horizontally for arranging the precious stones in the compartments so that the compartments point vertically upwardly. The precious stones can now be arranged in the compartments very easily, possibly also by an automated procedure. Then the second panel can be arranged on the compartments so that the decorative element according to the invention is finished. The compartments form a kind of cage out of which the stones cannot fall when the panels are arranged vertically.

Further advantageous configurations of the invention are defined in the dependent claims and are described in greater detail hereinafter.

In a particularly preferred embodiment of the invention both panels directly adjoin the compartments whereby the above-mentioned advantages, that the precious stones can no longer fall out of the compartments at the regions at which the compartments adjoin the panels are to be enjoyed in relation to both panels. That means that the decorative element is in the form of a sandwich composite element comprising two panels and the position-fixing device disposed therebetween with compartments and precious stones arranged therein, whereby the decorative element can have a compact optical appearance and can be particularly well used as a wall or facade element. The position of the precious stones perpendicularly to the planes of the panels can also be established by the panels directly adjoining the compartments, whereby the position of the precious stones can be fixed overall. In addition in that way the precious stones are particularly well protected from external influences, for example the influences of weather, or damage. Accordingly such a decorative element can be used for example as an advertising board mounted on an external facade.

In a particularly preferred embodiment of the invention the precious stones are held by the position-fixing device in a direction parallel to the surfaces of the panels, in which case the stones can be held mechanically. The fact that the precious stones are mechanically fixed in position in that way means that it is possible to dispense with adhesive with which the stones are glued in position in the previous state of the art, thereby permitting a saving of material. On the other hand that avoids a further disadvantage of the previous state of the art whereby an arrangement of the glued precious stones, once fixed, can no longer be released. The purely mechanical hold for the precious stones can be released so that the stones arranged in the position-fixing device can be rearranged in a technically simple fashion.

In addition an adhesive often has negative optical properties as frequently it does not have the same refractive index as the panels and the thickness of the adhesive layer between the panels is not the same everywhere. That disadvantage can also be circumvented with a position-fixing device according to the invention insofar as the precious stones are held mechanically by the device and in that case are not glued with adhesive to one of the panels. In that case the position-fixing device itself can be optically attractive and thereby can also serve decorative purposes.

In a further embodiment of the invention the precious stones are held in positively locking relationship by the position-fixing device or by the compartments of the device. For that purpose it can be provided that the position-fixing device is matched to the sizes of the precious stones. The positively locking connection provides that the precious stones are particularly well prevented from changing their position, whereby slipping thereof is rendered even more difficult, in particular during production of the composite panel assembly.

In a further embodiment of the invention the device for fixing the precious stones in position is of such a configuration that the precious stones can be arranged between the panels in grid form. That can make it possible to have a predetermined geometrical pattern, for example an ornamental arrangement of the precious stones, between the panels, wherein the precious stones remain in the selected pattern precisely because of the positional fixing means. It is particularly preferred in that respect for the compartments of the device to be arranged in a grid form. In that way it is particularly easily possible to produce a desired pattern with the precious stones insofar as only specifically selected compartments are provided with precious stones, in which the stones are then held. In order in that respect to achieve flexibility in relation to the pattern, it may be preferred if the grid is in the form of a matrix-form arrangement in rows and columns of the compartments. Particularly if the precious stones are of small dimensions in comparison with the panels and the compartments are approximately of the dimensions of the precious stones, the position-fixing device has a plurality of compartments, whereby there is a correspondingly large number of possible options in regard to positioning the precious stones. To achieve a certain optical impression however it can also be provided that the compartments are arranged in a non-regular form.

Particularly if only one precious stone can be arranged in the individual compartments, the compartments are approximately of the size of the precious stone. That means that the base surface of the compartment, which base surface is arranged parallel to the plane of the panels, is only slightly larger than the dimensions of the precious stone in that direction. The same applies to the direction perpendicular thereto, that is to say the height of the compartments. In addition arranging the precious stones without adhesive makes it easily possible to re-arrange the stones so that for example a new pattern is represented.

In an embodiment of the invention the compartments are of cross-sections with a curved, preferably circular edge. Those cross-sections are arranged parallel to the plane of the panel. In that case the edge surfaces are disposed perpendicularly to the panels and serve jointly with the panels for fixing the precious stones in position. It can be provided in that respect that the cross-sections of the compartments are of differing sizes, but it is preferred that the cross-sections of the compartments are substantially the same and involve the same cross-sectional area. For example it is possible to use circular compartments of diameters of between 5 and 15 mm, preferably between 8 and 12 mm.

In a further embodiment of the invention the compartments are of polygonal cross-sections. Those cross-sections are arranged parallel to the plane of the panel. The edge surfaces in that case are arranged perpendicularly to the panels and serve jointly with the panels for fixing the stones in position.

In a particularly preferred embodiment of the invention it is provided that the compartments are of a honeycomb configuration and the position-fixing device thus has a honeycomb structure. In that case the compartments are a pattern of substantially hexagonal hollow spaces arranged flat. That pattern can for example form a matrix-form grid. In that respect it may be preferred if the honeycombs are only of a slightly larger diameter and only a slightly larger height than the precious stones.

Such devices involving a honeycomb structure are known per se from other fields of technology, mostly by the name ‘honeycomb panel’, and are used for example in aircraft construction. The honeycomb structure of the device for fixing the precious stones in position affords a high level of mechanical strength with comparatively low weight, whereby the decorative elements according to the invention can be extremely nicely used for example as a room or wall element or as a facade element. It can be provided in that respect that the position-fixing device is made from plastic, for example polypropylene or polycarbonate. It is however also possible to use aluminum and aramide fibers, that is to say a so-called Nomex paper.

In an embodiment of the invention one of the panels comprises glass. Glass has the advantage in that respect that it can have a high degree of transparency and at the same time can be obtained by the manufacturer of the decorative element according to the invention easily and in various gauges and also with different glass colors. In addition such glass panels afford the esthetic desired for the living area.

In a further embodiment of the invention it is provided that at least one of the panels comprises plastic, for example plexiglas. That is particularly suitable for the situation where the decorative element according to the invention is to be used as a wall or facade element because plastic material is distinguished by a low weight and can be less easily damaged than glass. In the situation where a panel consisting of plastic material is damaged the risk of injury is also less than in the case of glass panels.

To combine the advantages of plastic and glass panels it is naturally also possible to use a glass panel on the side that is towards the viewer and a plastic panel on the side remote from the viewer, or vice-sera. Naturally it is also possible for both panels to be made of glass or both panels of plastic.

In an embodiment of the invention at least one of the panels is translucent to visible light, that is to say colorless and transparent, whereby the precious stones arranged within the panels can be particularly well seen.

In a further embodiment at least one of the panels is of a translucently colored nature, whereby further optically attractive effects can be achieved.

In a particularly preferred embodiment of the invention the device for fixing the precious stones in position is glued to at least one and preferably both panels. Particularly if the device for fixing the precious stones in position has compartments, that affords a further advantage of the invention. While in the state of the art adhesive is to be applied over the entire surface area, here at most the edges of the compartments have to be glued on to one of the panels, whereby a large amount of adhesive can be saved.

In general any minerals or stones which are known in the state of the art and which are generally perceived to be beautiful can be considered for the precious stones. Beads or pearls as well as gems or semi-precious stones can also be used. In that respect the precious stones can be natural or can also be produced artificially. In particular precious stones of plastic material can also be used. It is particularly preferred in that respect if a multiplicity of those precious stones are similar. Preferably the precious stones involve glass stones and/or in the case of the beads glass beads which once again can be inexpensively produced in large numbers and are nonetheless optically attractive, although naturally precious stones or beads of plastic material can also be used. To further enhance the esthetic impression a preferred embodiment of the invention provides that at least a plurality of the precious stones are ground. Particularly in the case of precious stones which are ground in a faceted fashion light refractions which are generally perceived to be beautiful occur at the edges between the respective facets. If a plurality of such precious stones are arranged between the panels those optical effects can be combined to give an attractive overall impression.

If both panels are at least partially translucent to visible light lighting of the precious stones by sunlight is possible, whereby a decorative element of that kind can be fitted for example in facade or window structures.

Besides lighting by sunlight, a further embodiment of the invention provides that the decorative element includes a lighting device so that the precious stones between the panels can be lit with artificial light. In that case the lighting device can be arranged externally or—if only one of the panels is at least partially translucent to visible light—between the panels, preferably in opposite relationship to the translucent panel. The lighting device can be arranged in or at a separate holding device, possibly in spaced relationship behind one of the panels.

Light emitting diodes are particularly suitable for that purpose, being distinguished by a high level of efficiency. Light emitting diodes can be inexpensively obtained, they have a low energy consumption and they have a low emission of heat while at the same time being of small dimensions. In addition light can be emitted in various colors, particularly if the lighting device includes a plurality of light emitting diodes of different colors.

In a further embodiment there is further provided a regulating and/or control device for the lighting device. In that way both the color and also the brightness or intensity of the light emitted by the lighting device can be regulated or controlled. That makes it possible to achieve particularly attractive optical effects. Thus various regions of the device and thus of the stones arranged between the panels can be lit with different colors and/or different levels of intensity.

It can also be provided for example by means of optical fibers to pass light to specific regions and to individually light up a plurality of compartments.

The invention further concerns a process for the production of a decorative element as described hereinbefore, wherein the position-fixing device is fixed, for example glued, to one of the panels. In regard to the arrangement of the precious stones they are sifted on to the device for fixing the precious stones in position. Particularly if the position-fixing device has compartments which can accommodate only one individual precious stone, such a sifting process provides that the precious stones are arranged in the compartments autonomously. If one of the compartments is already occupied by a precious stone the precious stone can of its own accord move into a free adjacent compartment. For that purpose a mechanical shaking process must possibly be used in support. The second panel is then fixed, for example again glued, to the position-fixing device. That results in a sandwich composite arrangement comprising two panels with the position-fixing device with precious stones, disposed therebetween. If the position-fixing device is of a height which is constant over the area of the first panel then the second panel is automatically oriented parallel to the first panel.

In the above-described process it can be provided that the position-fixing device has compartments which are somewhat larger than an individual stone or individual stones, whereby the precious stones are held loosely in the compartments. It is only essential in that respect that the precious stones cannot escape from the compartments in a direction parallel to the panels. In a further embodiment of the invention however it can be provided that the precious stones are pressed into the position-fixing device, that is to say for example into the compartments thereof. That is necessary particularly when the precious stones are somewhat larger than the compartments of the position-fixing device and the compartments have a certain elasticity. The fact of pressing the precious stones into place in that way provides that the precious stones are better held in the position-fixing device.

Further details and advantages of the present invention will be described more fully hereinafter by means of the specific description with reference to the drawings in which:

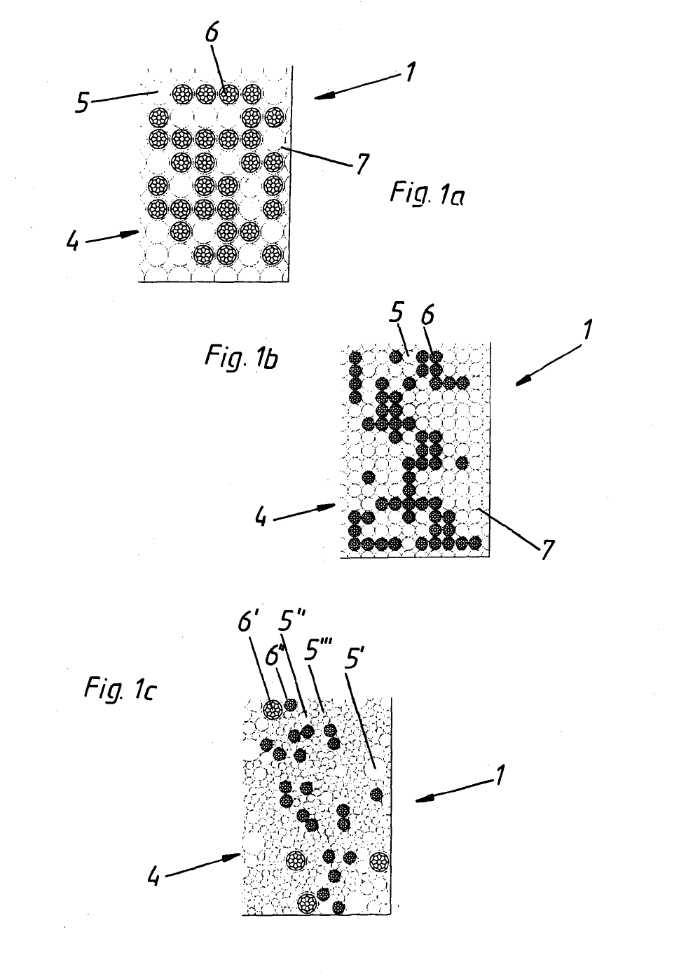

FIG. 1a through 1c show plan views of respective different embodiments of the decorative element according to the invention, and

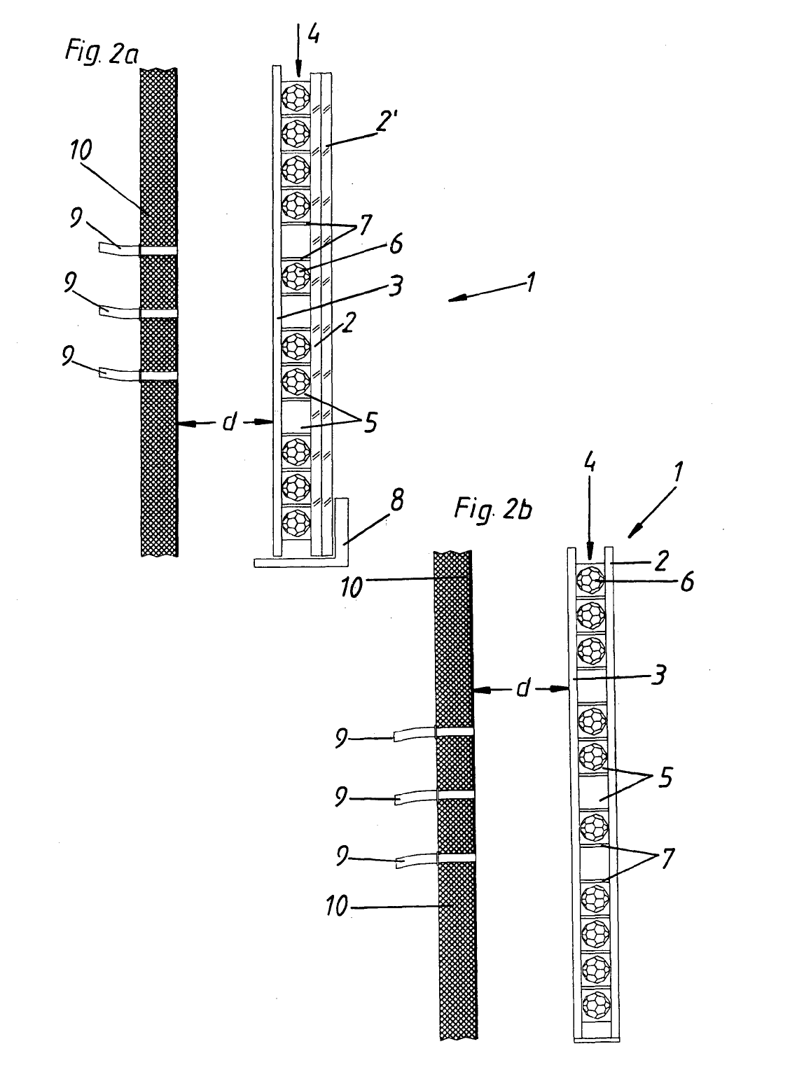

FIGS. 2a and 2b show cross-sectional side views of two decorative elements according to the invention with associated lighting devices.

FIG. 1a plan view showing a portion of a decorative element 1 according to the invention, wherein the device 4 for fixing the precious stones 6 in position has compartments 5 of a similar configuration, which are arranged in a grid consisting of rows and columns and the cross-sections of which have circular edges 7. In this case the compartments 5 are of such a size that precisely one precious stone 6 has space in each compartment 5. In this embodiment the precious stones 6 are of a similar configuration in the form of glass stones which are ground in a faceted configuration. Precious stones 6 are arranged in many of the compartments 5 so that the compartments 5 filled in that way form a pattern. The precious stones 6 are held in positively locking relationship by the compartments 5 and therefore cannot slip in the direction of the surface of the panels 2, 3. The directions of the panels 2, 3, that is to say the directions of the surfaces of the panels 2, 3, correspond in this view to the plane of the drawing. The precious stones 6 are held by the panels 2, 3 themselves, perpendicularly to the panel surfaces, so that slipping of the precious stones 6 overall is not possible and this arrangement provides for positional fixing of the precious stones 6.

A similar embodiment is shown in the plan view in FIG. 1b. Once again precious stones 6 are arranged in compartments 5 which are of a similar configuration as in FIG. 1a and are of a circular cross-section and are arranged in grid form. Not all compartments 5 are filled with precious stones 6 so that once again the arrangement of the precious stones 6 provides a pattern. The precious stones 6 are once again glass stones ground in a faceted configuration. Only the size of the compartments 5 and the precious stones 6 arranged therein represents a difference in relation to FIG. 1a. As here only a portion of a decorative element 1 according to the invention is shown, a very large number of compartments 5 can be filled with precious stones 6, depending on the respective size of the decorative element 1. Particularly when used as a facade element, the panel surfaces of the decorative element 1 can be several square meters in size and several thousand precious stones can be arranged between the panels 2, 3.

A portion of a further embodiment of a decorative element 1 according to the invention is shown in FIG. 1c. In this embodiment the compartments 5′, 5″, 5′″ are of different sizes, the edges 7 of the compartments 5′, 5″, 5′″ being of circular cross-sections. As in the above-discussed embodiments the compartments 5′, 5″, 5′″ form the device 4 for fixing the precious stones 6′, 6″ in position and are made for example of plastic. The precious stones 6′, 6″ are in the form of glass stones which are ground in a faceted configuration and are of different sizes which however correspond to the sizes of the compartments 5′, 5″, 5′″. The compartments 5′, 5″, 5′″ are irregularly distributed and do not form a grid in this embodiment.

FIG. 2a shows a cross-sectional side view of a decorative element 1 according to the invention. The decorative element 1 comprises two mutually spaced parallel panels 2, 3. A further panel 2′ is arranged in front of the panel 2 in the direction of the viewer. Both the panels 2, 2′ and also the panel 3 are at least partially transparent to visible light so that on the one hand a viewer can observe the precious stones 6 between the panels 2, 3 and on the other hand a lighting device 9 in the form of a fiber optic can light up the precious stones 6 from the side of the decorative element 1, that is remote from the viewer. The lighting device 9 itself is held in spaced relationship behind the second panel 3 by a holding device 10. The spacing d between the holding device 10 and the second panel 3 in this embodiment is about 12 cm but can be of any other values. The precious stones 6 are held by a position-fixing device 4, wherein compartments 5 are of a size such that a respective precious stone 6 can be arranged in each compartment 5 and is held in positively locking relationship by the edge surfaces 7 of the compartments 5 in the direction of the panel surface and by the panels 2, 3 in a direction perpendicular thereto. Many of the compartments 5 are empty while others thereof are filled with precious stones 6, whereby they can form a pattern. In this case a holding element 8 serves to orient the decorative element 1. The precious stones 6 can be lit with the lighting device 9 so that in that case the precious stones 6 leave behind an optically attractive sparkling impression by virtue of multiple light refraction, in particular at the edges between the facets. Various regions of the decorative element 1 can in this case be lit with different colors and/or different levels of intensity. In this embodiment the height of the compartments 5, that is to say the spacing between the panels 2 and 3, is of a value of about 1 cm. Depending on the respective magnitude of that value, various sizes of precious stones 6 can be arranged between the panels 2, 3. The panel 3 towards the lighting device 9 is thinner than the panels 2 and 2′ and can possibly be made from different material, for example plastic. This view particularly clearly shows how the precious stones 6 are fixed in position by the compartments 5, that is to say by the edge surfaces 7 of the compartments 5, that is to say overall by the device 4.

FIG. 2b shows a similar embodiment, in this case the panels 2 and 3 being similar, that is to say being of the same thickness. In this case there is no additional panel 2′.

1. A decorative element comprising two mutually spaced substantially parallel panels, wherein at least one of the panels is at least partially translucent for visible light, and a plurality of precious stones arranged between the panels, wherein disposed between the panels is a device for fixing the position of the precious stones and wherein the position-fixing device has compartments in which precisely one respective precious stone is arranged, wherein at least one of the panels directly adjoins the compartments.

2. A decorative element as set forth in claim 1 wherein both panels directly adjoin the compartments.

3. A decorative element as set forth in claim 1 wherein the precious stones are held by the position-fixing device in a direction parallel to the surfaces of the panels.

4. A decorative element as set forth in claim 2 wherein the precious stones are held by the position-fixing device in a direction parallel to the surfaces of the panels.

5. A decorative element as set forth in claim 1 wherein the precious stones are held by the position-fixing device in positively locking relationship.

6. A decorative element as set forth in claim 2 wherein the precious stones are held by the position-fixing device in positively locking relationship.

7. A decorative element as set forth in claim 5, wherein the precious stones are held by the position-fixing device in positively locking relationship by the compartments.

8. A decorative element as set forth in claim 1 wherein the position-fixing device for the precious stones is of such a configuration that the precious stones can be arranged in grid form between the panels.

9. A decorative element as set forth in claim 8 wherein the compartments of the position-fixing device for the precious stones are of a grid shape.

10. A decorative element as set forth in claim 1 wherein the compartments have cross-sections with curved edges.

11. A decorative element as set forth in claim 1 wherein the compartments have cross-sections with circular edges.

12. A decorative element as set forth in claim 1 wherein the compartments are of polygonal cross-sections.

13. A decorative element as set forth in claim 1 wherein the compartments are of a honeycomb configuration.

14. A decorative element as set forth in claim 2 wherein the compartments have cross-sections with curved edges.

15. A decorative element as set forth in claim 2 wherein the compartments have cross-sections with circular edges.

16. A decorative element as set forth in claim 2 wherein the compartments are of polygonal cross-sections.

17. A decorative element as set forth in claim 2 wherein the compartments are of a honeycomb configuration.

18. A decorative element as set forth in claim 1 wherein the precious stones are glass stones or glass beads.

19. A decorative element as set forth in claim 1 wherein the precious stones are ground faceted.

20. A decorative element as set forth in claim 1 wherein at least one of the panels is a glass panel.

21. A decorative element as set forth in claim 1 wherein at least one of the panels comprises plastic material.

22. A decorative element as set forth in claim 1 wherein at least one of the panels is transparent to visible light.

23. A decorative element as set forth in claim 1 wherein at least one of the panels is translucently colored.

24. A decorative element as set forth in claim 1 wherein the position-fixing device for the precious stones is glued to at least one of the panels.

25. A decorative element as set forth in claim 1 wherein the position-fixing device for the precious stones is glued to both panels.

26. A decorative element as set forth in claim 1 wherein the decorative element further includes at least one lighting device so that the precious stones between the panels can be lit.

27. A decorative element as set forth in claim 26 wherein the lighting device includes one or more light emitting diodes.

28. A decorative element as set forth in claim 26, wherein the lighting device includes a fiber optic.

29. A decorative element as set forth in claim 26 wherein the lighting device includes a regulating or control device with which the color and/or brightness of the light emitted by the lighting device can be regulated or controlled.

30. A decorative element as set forth in claim 26 wherein the lighting device includes means with which a plurality of compartments of the position-fixing device can be individually lit.

31. A process for the production of a decorative element as set forth in claim 1 characterised by the following steps:
fixing the position-fixing device for the precious stones to one of the panels,
sifting the precious stones on to the position-fixing device for the precious stones, and
fixing the second panel to the position-fixing device for the precious stones, that is provided with precious stones.

32. A process as set forth in claim 31 wherein the precious stones are pressed after the sifting operation into the position-fixing device and wherein the position-fixing device for the precious stones is glued to at least one of the panels.
